(19) United States
(12) Patent Application Publication
(10) Pub. No.: US 2007/0239526 A1
(43) Pub. Date: Oct. 11, 2007

(54) Providing a personalized media stream via a targeted advertising model

(76) Inventor: Frank Andrew Welts, San Luis Obispo, CA (US)

Correspondence Address: PROXURE INCORPORATED, 3940-7 BROAD STREET, # 175, SAN LUIS OBISPO, CA, 93401, US

(21) Appl. No.: 11/308,569

(22) Filed: Apr. 7, 2006

(51) Int. Cl. G06Q 30/00

(52) U.S. Cl. 705/14

(57) ABSTRACT

A computer network server provides a customized media stream containing relevant, targeted advertising to a recipient according to recipient profile preferences. This is accomplished as follows. The recipient requests media from the server. The server searches for and obtains content that is deemed to be of greatest interest to the recipient according to profile settings of the recipient and the media content being requested. The media is then delivered to the recipient containing relevant advertising targeted directly for the recipient.

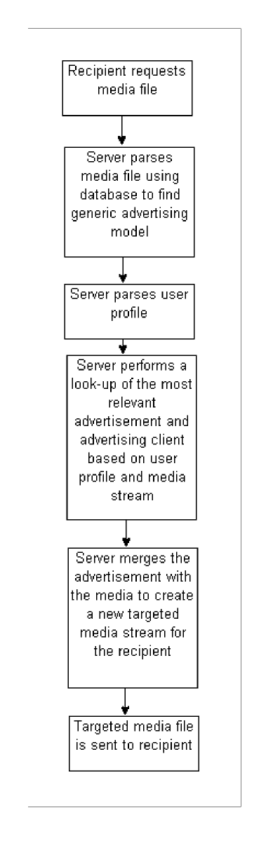

### TECHNICAL FIELD

The present invention pertains generally to the use of computer networks, and pertains more particularly to improved ways to distribute relevant advertising to specific recipients through computer networks.

### BACKGROUND ART

Prior to the wide spread use of global computer networks, many individuals relied on direct media like radio and television broadcasts to obtain information for media content. Today, global computer networks such as the Internet provide an additional source of media access. For some individuals, computer network sources have eclipsed the importance of the older, more traditional media because these networks are capable of supporting extremely rapid publication of large amounts of information. Media content is made accessible through the Internet, for example, is given a unique identifier or Uniform Resource Locator (URL). As a result, individuals may be given direct access to information from essentially any source throughout the world. Advertisers generally target information and attempt to insert meaningful advertisements based on content of the information. This is a mixed blessing. Generic advertising targeting can lead to misplaced and inappropriate advertisements. Using a database containing profile information of the recipient the advertising can be better targeted to the individual.

The invention claimed is:

1. A method performed by one or more electronic apparatuses for providing a personalized presentation of media to a recipient comprising steps that perform the acts of:
a. obtaining profile information of the recipient such as age, sex, geographical region, income, etc;
b. obtaining information about the media stream
c. mapping the above information into a relevant advertising model
d. mapping the relevant advertising model with a list of advertising clients and selecting the most relevant advertisement for the recipient
e. merging the media stream with the advertisement
f. presenting the unified media stream to the recipient.
